(19) United States
(12) Patent Application Publication
(10) Pub. No.: US 2025/0131473 A1
(43) Pub. Date: Apr. 24, 2025

(54) CUSTOMER VALUE PREDICTING METHOD AND SYSTEM THEREOF BASED ON ARTIFICIAL INTELLIGENCE MULTILAYER PERCEPTRON AND COMPUTER READABLE RECORDING MEDIUM

(71) Applicant: NATIONAL CHIN-YI UNIVERSITY OF TECHNOLOGY, Taichung (TW)

(72) Inventors: Chi-Tung CHEN, Taichung (TW); Yi-Xuan WU, Taichung (TW); Jhih Jyuan CHANG, Taichung (TW); Yi-Hsuan LAI, Taichung (TW)

(21) Appl. No.: 18/660,228

(22) Filed: May 10, 2024

(30) Foreign Application Priority Data
Oct. 19, 2023 (TW) 112139996

(51) Int. Cl. G06Q 30/0251

(52) U.S. Cl. CPC G06Q 30/0255

(57) ABSTRACT

A customer value predicting method based on an artificial intelligence multilayer perceptron includes performing a data acquiring step, a customer value analyzing step, a grouping step, a predicting model establishing step and a predicting step. The data acquiring step includes acquiring a plurality of sales data from a cloud database. The customer value analyzing step includes analyzing a plurality of customer value indexes of a plurality of customers according to the sales data. The grouping step includes dividing the customers into a plurality of groups according to the customer value indexes. The predicting model establishing step includes establishing a predicting model according to a multilayer perceptron. The predicting step includes inputting one of the customer value indexes of an ungrouped customer into the predicting model to predict one of the groups corresponding to the one of the customer.

### RELATED APPLICATIONS

This application claims priority to Taiwan Application Serial Number 112139996, filed Oct. 19, 2023, which is herein incorporated by reference.

### BACKGROUND

### Technical Field

The present disclosure relates to a customer value predicting method and a system thereof and a computer readable recording medium. More particularly, the present disclosure relates to a customer value predicting method and a system thereof based on an artificial intelligence multilayer perceptron and a computer readable recording medium.

### Description of Related Art

Due to continued advancement of technology, the consumption habits of the customers have changed. On-line shopping has replaced most of the physical shopping. Thus, calculating and analyzing the shopping records of the customers are favorable for providing different sales strategies to target customers with different consumption habits. Moreover, due to an increase in the shopping records and the large data amount of the customers, the calculating time, the analyzing time and the efficiency requirement of the calculating devices have also increased.

Therefore, a customer value predicting method and a system thereof based on an artificial intelligence multilayer perceptron and a computer readable recording medium which can generate different sales strategies to target customers with different brand loyalty, would be commercially desirable as it can be used to increase brand loyalty and provide great consumption experience to customers.

### SUMMARY

According to one aspect of the present disclosure, a customer value predicting method based on an artificial intelligence multilayer perceptron includes performing a data acquiring step, a customer value analyzing step, a grouping step, a predicting model establishing step and a predicting step. The data acquiring step includes configuring a processor to acquire a plurality of sales data from a cloud database. The customer value analyzing step includes configuring the processor to analyze a plurality of customer value indexes of a plurality of customers according to the sales data. The grouping step includes configuring the processor to divides the customers into a plurality of groups according to the customer value indexes. The predicting model establishing step includes configuring the processor to establish a predicting model according to a multilayer perceptron. The predicting step includes configuring the processor to input one of the customer value indexes of an ungrouped customer into the predicting model to predict one of the groups corresponding to the one of the customer.

According to another aspect of the present disclosure, a customer value predicting system based on an artificial intelligence multilayer perceptron includes a cloud database and a processor. The cloud database includes a plurality of sales data. The processor is signally connected to the cloud database, and is configured to perform a customer value predicting method based on the artificial intelligence multilayer perceptron. The customer value predicting method based on the artificial intelligence multilayer perceptron includes performing a data acquiring step, a customer value analyzing step, a grouping step, a predicting model establishing step and a predicting step. The data acquiring step includes acquiring the sales data from the cloud database. The customer value analyzing step includes analyzing a plurality of customer value indexes of a plurality of customers according to the sales data. The grouping step includes dividing the customers into a plurality of groups according to the customer value indexes. The predicting model establishing step includes establishing a predicting model according to a multilayer perceptron. The predicting step includes inputting one of the customer value indexes of an ungrouped customer into the predicting model to predict one of the groups corresponding to the one of the customer.

According to further another aspect of the present disclosure, a computer readable recording medium is provided. It includes a program for a processor capable of predicting one of a plurality of groups, to execute a customer value predicting method based on an artificial intelligence multilayer perceptron. The customer value predicting method based on the artificial intelligence multilayer perceptron includes performing a data acquiring step, a customer value analyzing step, a grouping step, a predicting model establishing step and a predicting step. The data acquiring step includes configuring the processor to acquire a plurality of sales data from a cloud database. The customer value analyzing step includes configuring the processor to analyze a plurality of customer value indexes of a plurality of customers according to the sales data. The grouping step includes configuring the processor to divides the customers into the groups according to the customer value indexes. The predicting model establishing step includes configuring the processor to establish a predicting model according to a multilayer perceptron. The predicting step includes configuring the processor to input one of the customer value indexes of an ungrouped customer into the predicting model to predict one of the groups corresponding to the one of the customer.

### BRIEF DESCRIPTION OF THE DRAWINGS

The present disclosure can be more fully understood by reading the following detailed description of the embodiment, with reference made to the accompanying drawings as follows:

FIG. 1 shows a flow chart of a customer value predicting method based on an artificial intelligence multilayer perceptron according to a first embodiment of the present disclosure.

FIG. 2 shows a schematic view of a customer value predicting system based on the artificial intelligence multilayer perceptron according to a second embodiment of the present disclosure.

FIG. 3 shows a schematic view of a multilayer perceptron of the customer value predicting system based on the artificial intelligence multilayer perceptron of FIG. 2.

FIG. 4 shows a flow chart of a customer value predicting method based on an artificial intelligence multilayer perceptron according to a third embodiment of the present disclosure.

FIG. 5 shows a schematic view of a customer value predicting system based on an artificial intelligence multilayer perceptron according to a fourth embodiment of the present disclosure.

### DETAILED DESCRIPTION

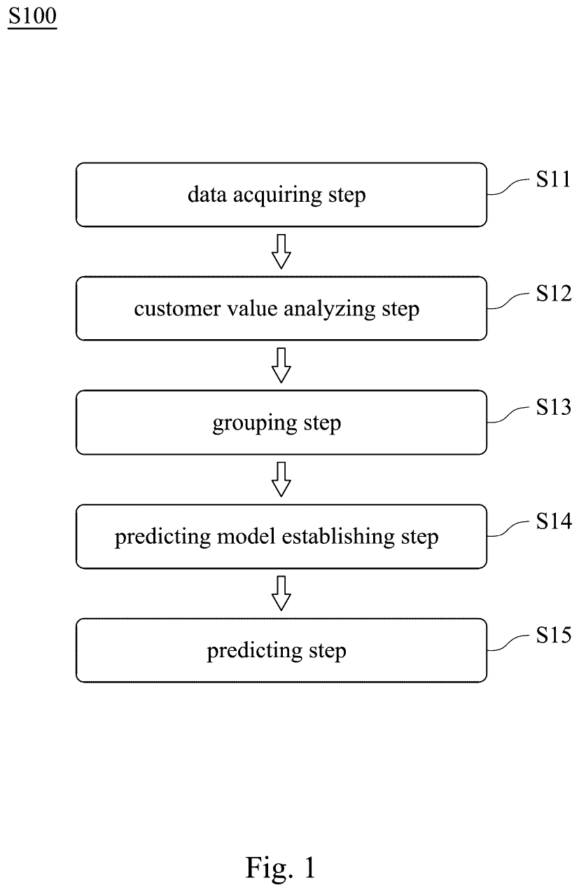

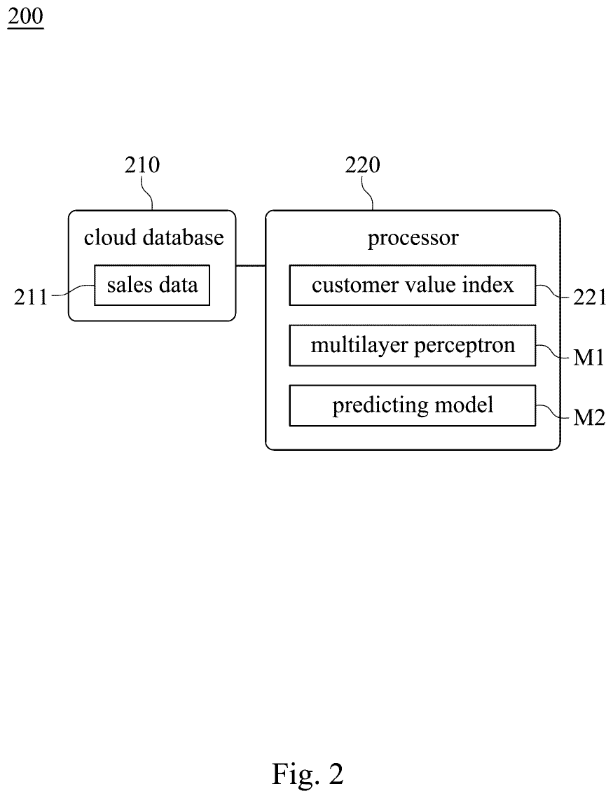

Please refer to FIG. 1 and FIG. 2. FIG. 1 shows a flow chart of a customer value predicting method S100 based on an artificial intelligence multilayer perceptron according to a first embodiment of the present disclosure. FIG. 2 shows a schematic view of a customer value predicting system 200 based on the artificial intelligence multilayer perceptron according to a second embodiment of the present disclosure. The customer value predicting system 200 based on the artificial intelligence multilayer perceptron includes a cloud database 210 and a processor 220. The cloud database 210 includes a plurality of sales data 211.

The processor 220 is signally connected to the cloud database 210, and is configured to perform the customer value predicting method S100 based on the artificial intelligence multilayer perceptron. The customer value predicting method S100 based on the artificial intelligence multilayer perceptron includes performing a data acquiring step S11, a customer value analyzing step S12, a grouping step S13, a predicting model establishing step S14 and a predicting step S15. The data acquiring step S11 includes acquiring the sales data 211 from the cloud database 210. The customer value analyzing step S12 includes analyzing a plurality of customer value indexes 221 of a plurality of customers according to the sales data 211. The grouping step S13 includes dividing the customers into a plurality of groups according to the customer value indexes 221. The predicting model establishing step S14 includes establishing a predicting model M2 according to a multilayer perceptron M1. The predicting step S15 includes inputting one of the customer value indexes 221 of an ungrouped customer into the predicting model M2 to predict one of the groups corresponding to the one of the customers. Thus, the customer value predicting method S100 based on the artificial intelligence multilayer perceptron of the present disclosure can analyze the data of the customers that have not been grouped, by analyzing and classifying the customer value indexes 221 of the customer via the artificial intelligence deep learning technology with the multilayer perceptron M1.

In detail, the cloud database 210 can be a memory, an online retail transaction cloud database or other data storing device, the processor 220 can be a central processing unit (CPU), a virtual private server (VPS) or other electrical computing device, but the present disclosure is not limited thereto.

In one embodiment, during the data acquiring step S11, the processor 220 can acquire the sales data 211 of the stores from a database (i.e., the cloud database 210) of an online shopping website. One of the sales data 211 includes a customer code, a sales date, a sales item and a sales revenue, but the present disclosure is not limited thereto.

In the customer value analyzing step S12, the sales data 211 are transformed by the processor 220 into the customer value indexes 221 that match to the corresponding customers. Some examples of these customer value indexes 221 can be listed in Table 1. Each of the customer value indexes 221 includes a “most recent purchasing day”, a “purchasing frequency” and an “annual revenue”, which are corresponding to each of the customers. The most recent purchasing day represents the number of days counted from the corresponding customer's most recent purchasing date to the current date. The purchasing frequency represents the annual number of purchase made by the corresponding customer. The annual revenue represents the total amount spent (in US dollars) on purchase by the corresponding customer for the whole year.

TABLE 1

| | most recent | purchasing frequency | annual revenue |
|---|---|---|---|
| customer code | purchasing day | (per year) | (US dollar) |
| 12346 | 326 | 2 | 2.08 |
| 12347 | 3 | 182 | 481.21 |
| 12348 | 76 | 31 | 178.71 |
| 12349 | 19 | 73 | 605.1 |
| 12350 | 311 | 17 | 65.3 |
| 12352 | 37 | 95 | 2211.1 |
| 12353 | 205 | 4 | 24.3 |
| 12354 | 233 | 58 | 261.22 |
| 12355 | 215 | 13 | 54.65 |
| 12356 | 23 | 59 | 188.87 |

In detail, in the grouping step S13, the customers are divided into the groups according to a Kohonen self-organizing map algorithm. Specifically, the customers are divided into three groups (i.e., a first group, a second group and a third group) based on the analysis of each customer's most recent purchasing day, the purchasing frequency and the annual revenue using the Kohonen self-organizing map algorithm. The grouping results corresponding to each of the customers are listed in Table 2, and a total proportion of the customers and the customer value indexes 221 corresponding to the three groups can be listed in Table 3. In Table 3, the most recent purchasing day of the third group is the lowest, while the purchasing frequency and the annual revenue of the third group are the highest, indicating that, the third group is an important target customer group. In other embodiments of the present disclosure, the customers can be divided into four groups depending on the accuracy of the grouping results, but the present disclosure is not limited thereto.

TABLE 2

| | most recent | purchasing | | |
|---|---|---|---|---|
| customer | purchasing | frequency | annual revenue | |
| code | day | (per year) | (US dollar) | group |
| 12346 | 326 | 2 | 2.08 | first group |
| 12347 | 3 | 182 | 481.21 | third group |
| 12348 | 76 | 31 | 178.71 | second group |
| 12349 | 19 | 73 | 605.1 | third group |
| 12350 | 311 | 17 | 65.3 | first group |
| 12352 | 37 | 95 | 2211.1 | third group |
| 12353 | 205 | 4 | 24.3 | first group |
| 12354 | 233 | 58 | 261.22 | first group |
| 12355 | 215 | 13 | 54.65 | first group |
| 12356 | 23 | 59 | 188.87 | third group |

TABLE 3

| | first group | second group | third group |
|---|---|---|---|
| total proportion | 25.8% | 17.2% | 57% |
| most recent | 244.88 | 91.83 | 23.89 |
| purchasing day | | | |
| purchasing | 29.62 | 49.7 | 392.34 |
| frequency | | | |
| (per year) | | | |
| annual revenue | 150.92 | 163.19 | 885.11 |
| (US dollar) | | | |

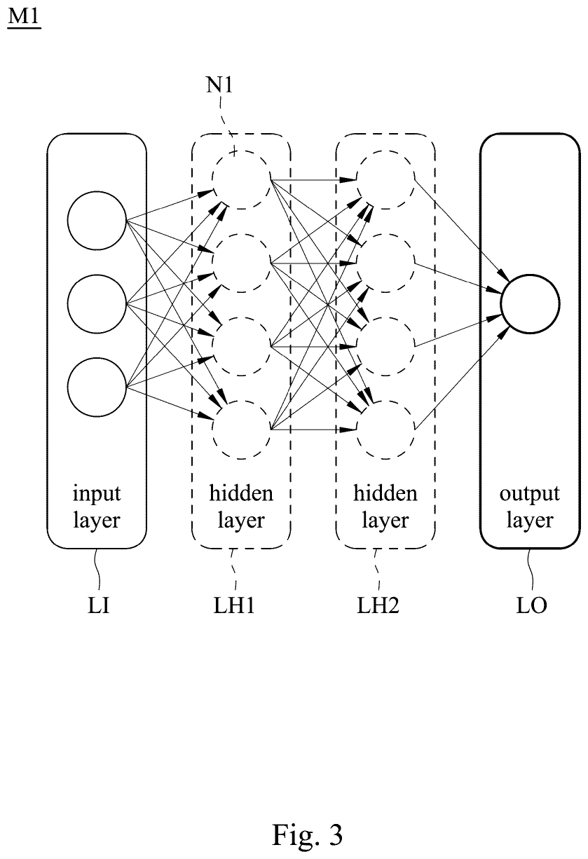

Moreover, please refer to FIG. 1 to FIG. 3. FIG. 3 shows a schematic view of a multilayer perceptron M1 of the customer value predicting system 200 based on the artificial intelligence multilayer perceptron of FIG. 2. The predicting model establishing step S14 is configured to establish the predicting model M2, and the predicting model M2 is for predicting the group, based on analysis of the customer value index 221 of a customer who has not been grouped by the grouping step S13. When there are a huge number of the customers, and the amount of the sales data 211 and the customer value indexes 221 are correspondingly enormous, the predicting model M2 can be established by the multilayer perceptron M1 so as to establish a predicting model M2 with high accuracy. The multilayer perceptron M1 includes an input layer LI, a plurality of hidden layers LH1, LH2 and an output layer LO. The hidden layers LH1, LH2 are connected to the input layer LI, and each of the hidden layers LH1, LH2 includes a plurality of neurons N1. The hidden layer LH1 is connected between the input layer LI and the hidden layer LH2. The hidden layer LH2 is connected between the output layer LO and the hidden layer LH1.

Further, the neurons N1 in each layers of the multilayer perceptron M1 are connected to each other. The neurons N1 of the previous layer are weighted and inputted to the current layer, integrated with the neurons N1 of the current layer, and then transmitted to the neurons N1 of the next layer. The predicting accuracy of the predicting model M2 can be increased by adjusting the number of the hidden layers of the multilayer perceptron M1 or adjusting the number of the neurons N1 in each of the hidden layers. A number of the hidden layer can be at least two. Moreover, during the training process of the multilayer perceptron M1, the processor 220 can randomly omit a portion of the neurons N1 in each of the hidden layers to avoid having the analysis results of the predicting model M2 being too close to the current training data, leading to an inability to predict the data accurately (i.e., overfitting).

In the predicting step S15, the customer value indexes 221 of the customers without grouping by the grouping step S13 are inputted to the predicting model M2 by the processor 220. Thus, the customer value predicting system 200 based on the artificial intelligence multilayer perceptron of the present disclosure can rapidly assist the enterprises to analyze the customer features as according to the sales data 211.

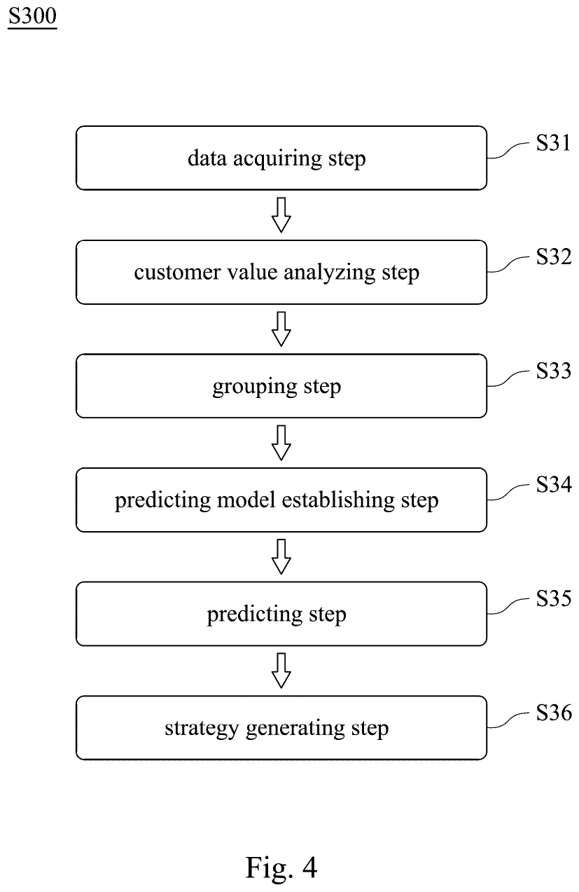

Please refer to FIG. 1, FIG. 2 and FIG. 4. FIG. 4 shows a flow chart of a customer value predicting method S300 based on an artificial intelligence multilayer perceptron according to a third embodiment of the present disclosure. The customer value predicting method S300 based on the artificial intelligence multilayer perceptron includes performing a data acquiring step S31, a customer value analyzing step S32, a grouping step S33, a predicting model establishing step S34, a predicting step S35 and a strategy generating step S36. In the third embodiment, the data acquiring step S31, the customer value analyzing step S32, the grouping step S33, the predicting model establishing step S34 and the predicting step S35 are the same as the data acquiring step S11, the customer value analyzing step S12, the grouping step S13, the predicting model establishing step S14 and the predicting step S15 of the customer value predicting method S100 based on the artificial intelligence multilayer perceptron of the first embodiment, respectively, and will not be described again. Furthermore, the strategy generating step S36 includes configuring the processor 220 to generate a sales strategy targeted to the one of the groups corresponding to each of the customers.

In detail, in the strategy generating step S36, a sales strategy can be provided to target customers in different groups after the customers have been grouped. For instance, in Table 3, among the three groups, the most recent purchasing day of the customers in the first group is highest, the purchasing frequency of the customers in the first group is lowest, and the annual revenue of the customers in the first group is the lowest. Therefore, the customers in the first group may be customers who are recently introduced to the analyzed brand, and the customers in the first group seldom purchase the products of the analyzed brand. The most recent purchasing day of the second group is lower than that of the first group. The purchasing frequency and the annual revenue of the second group are also higher than the corresponding indexes found in the first group. Thus, the customers in the second group likely have a sense of identity with the analyzed brand and may be willing to repurchase the products of the analyzed brand. The most recent purchasing day of the third group is the lowest, while the purchasing frequency and the annual revenue of the third group are the highest. This may indicate that the customers in the third group have high customer loyalty, and their consumption habits are regular. The strategy generating step S36 can provide sales strategies, which can increase the purchasing willingness of the customers in the first group and the second group, and also provide sales events offering product discounts to the customers in the third group to further increase the consumption revenue. Thus, the customer value predicting method S300 based on the artificial intelligence multilayer perceptron of the present disclosure can increase the brand loyalty of the customers and provide great consumption experience.

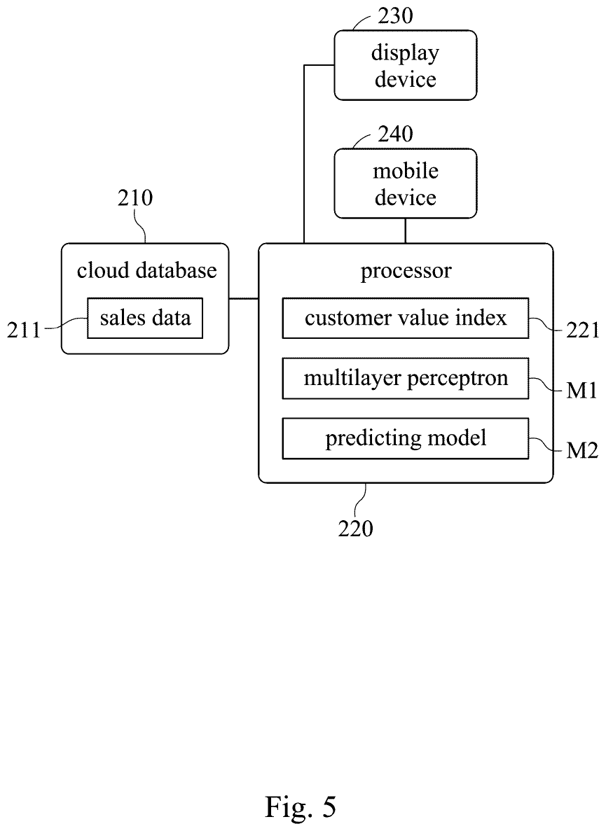

Please refer to FIG. 1, FIG. 2 and FIG. 5. FIG. 5 shows a schematic view of a customer value predicting system 200a based on an artificial intelligence multilayer perceptron according to a fourth embodiment of the present disclosure. The customer value predicting system 200a based on the artificial intelligence multilayer perceptron includes a cloud database 210, a processor 220, a display device 230 and a mobile device 240. The cloud database 210 includes a plurality of sales data 211. The processor 220 is signally connected to the cloud database 210, and is configured to perform the customer value predicting method S100 based on the artificial intelligence multilayer perceptron in the first embodiment or the customer value predicting method S300 based on the artificial intelligence multilayer perceptron in the third embodiment, but the present disclosure is not limited thereto. In the fourth embodiment, the cloud database 210 and the processor 220 can be the same as the cloud database 210 and the processor 220 in the second embodiment, respectively, and will not be described again. Moreover, the display device 230 and the mobile device 240 are electrically connected to the processor 220. The user can view the groups of each of the customers and the corresponding sales strategies by connecting the display device 230 or the mobile device 240 to the processor 220 electrically. Thus, the customer value predicting system 200a based on the artificial intelligence multilayer perceptron of the present disclosure can allow the user to check the sales strategy via the display device 230 or the mobile device 240.

A computer readable recording medium includes a program for a processor capable of predicting one of a plurality of groups, and to execute the customer value predicting methods S100 and S300 based on the artificial intelligence multilayer perceptron. The computer readable recording medium can be a CR-ROM, a flexible disk (FD), a CD-R, a digital versatile disk (DVD), a USB medium and a flash memory, but the present disclosure is not limited thereto.

According to the aforementioned embodiments and examples, the advantages of the present disclosure are described as follows.
1. The customer value predicting method based on the artificial intelligence multilayer perceptron of the present disclosure can analyze the data of the customers who are not grouped, by analyzing and classifying the customer value indexes of the customer via the artificial intelligence deep learning technology with the multilayer perceptron.
2. The customer value predicting system based on the artificial intelligence multilayer perceptron of the present disclosure can assist the enterprises to rapidly analyze the customer feature according to the sales data.
3. The customer value predicting method based on the artificial intelligence multilayer perceptron of the present disclosure can increase the brand loyalty of the customer and provide great consumption experience.
4. The customer value predicting system based on the artificial intelligence multilayer perceptron of the present disclosure can allow an user to check the sales strategy via a display device or a mobile device.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A customer value predicting method based on an artificial intelligence multilayer perceptron, comprising:
performing a data acquiring step, wherein the data acquiring step comprises configuring a processor to acquire a plurality of sales data from a cloud database;
performing a customer value analyzing step, wherein the customer value analyzing step comprises configuring the processor to analyze a plurality of customer value indexes of a plurality of customers according to the sales data;
performing a grouping step, wherein the grouping step comprises configuring the processor to divides the customers into a plurality of groups according to the customer value indexes;
performing a predicting model establishing step, wherein the predicting model establishing step comprises configuring the processor to establish a predicting model according to a multilayer perceptron; and
performing a predicting step, wherein the predicting step comprises configuring the processor to input one of the customer value indexes of an ungrouped customer into the predicting model to predict one of the groups corresponding to the one of the customer.

2. The customer value predicting method based on the artificial intelligence multilayer perceptron of claim 1, wherein in the grouping step, the customers are divided into the groups according to a Kohonen self-organizing map algorithm.

3. The customer value predicting method based on the artificial intelligence multilayer perceptron of claim 1, wherein one of the sales data comprises a customer code, a sales date, a sales item and a sales revenue, and each of the customer value indexes comprises a most recent purchasing day, a purchasing frequency and an annual revenue, which are corresponding to each of the customers.

4. The customer value predicting method based on the artificial intelligence multilayer perceptron of claim 1, wherein the multilayer perceptron comprises:
an input layer;
a plurality of hidden layers connected to the input layer, and each of the hidden layers comprises a plurality of neurons; and
an output layer connected to one of the hidden layers.

5. The customer value predicting method based on the artificial intelligence multilayer perceptron of claim 1, further comprising:
performing a strategy generating step, wherein the strategy generating step comprises configuring the processor to generate a sales strategy targeted to the one of the groups corresponding to each of the customers.

6. A customer value predicting system based on an artificial intelligence multilayer perceptron, comprising:
a cloud database comprising a plurality of sales data; and
a processor signally connected to the cloud database, and configured to perform a customer value predicting method based on the artificial intelligence multilayer perceptron comprising:
performing a data acquiring step, wherein the data acquiring step comprises acquiring the sales data from the cloud database;
performing a customer value analyzing step, wherein the customer value analyzing step comprises analyzing a plurality of customer value indexes of a plurality of customers according to the sales data;
performing a grouping step, wherein the grouping step comprises dividing the customers into a plurality of groups according to the customer value indexes;
performing a predicting model establishing step, wherein the predicting model establishing step comprises establishing a predicting model according to a multilayer perceptron; and
performing a predicting step, wherein the predicting step comprises inputting one of the customer value indexes of an ungrouped customer into the predicting model to predict one of the groups corresponding to the one of the customer.

7. The customer value predicting system based on the artificial intelligence multilayer perceptron of claim 6, wherein in the grouping step, the customers are divided into the groups according to a Kohonen self-organizing map algorithm.

8. The customer value predicting system based on the artificial intelligence multilayer perceptron of claim 6, wherein one of the sales data comprises a customer code, a sales date, a sales item and a sales revenue, and each of the customer value indexes comprises a most recent purchasing day, a purchasing frequency and an annual revenue, which are corresponding to each of the customers.

9. The customer value predicting system based on the artificial intelligence multilayer perceptron of claim 6, wherein the multilayer perceptron comprises:
an input layer;
a plurality of hidden layers connected to the input layer, and each of the hidden layers comprises a plurality of neurons; and
an output layer connected to one of the hidden layers.

10. The customer value predicting system based on the artificial intelligence multilayer perceptron of claim 6, wherein the processor comprises:
performing a strategy generating step, wherein the strategy generating step comprises generating a sales strategy targeted to the one of the groups corresponding to each of the customers.

11. A computer readable recording medium storing a program for a processor capable of predicting one of a plurality of groups, to execute a customer value predicting method based on an artificial intelligence multilayer perceptron comprising:
performing a data acquiring step, wherein the data acquiring step comprises configuring the processor to acquire a plurality of sales data from a cloud database;
performing a customer value analyzing step, wherein the customer value analyzing step comprises configuring the processor to analyze a plurality of customer value indexes of a plurality of customers according to the sales data;
performing a grouping step, wherein the grouping step comprises configuring the processor to divides the customers into the groups according to the customer value indexes;
performing a predicting model establishing step, wherein the predicting model establishing step comprises configuring the processor to establish a predicting model according to a multilayer perceptron; and
performing a predicting step, wherein the predicting step comprises configuring the processor to input one of the customer value indexes of an ungrouped customer into the predicting model to predict one of the groups corresponding to the one of the customer.

12. The computer readable recording medium of claim 11, wherein in the grouping step, the customers are divided into the groups according to a Kohonen self-organizing map algorithm.

13. The computer readable recording medium of claim 11, wherein one of the sales data comprises a customer code, a sales date, a sales item and a sales revenue, and each of the customer value indexes comprises a most recent purchasing day, a purchasing frequency and an annual revenue, which are corresponding to each of the customers.

14. The computer readable recording medium of claim 11, wherein the multilayer perceptron comprises:
an input layer;
a plurality of hidden layers connected to the input layer, and each of the hidden layers comprises a plurality of neurons; and
an output layer connected to one of the hidden layers.

15. The computer readable recording medium of claim 11, wherein the customer value predicting method based on the artificial intelligence multilayer perceptron further comprises:
performing a strategy generating step, wherein the strategy generating step comprises configuring the processor to generate a sales strategy targeted to the one of the groups corresponding to each of the customers.
